(19) United States
(12) Patent Application Publication
(10) Pub. No.: US 2024/0178406 A1
(43) Pub. Date: May 30, 2024

(54) SOLID OXIDE CELL

(71) Applicant: SAMSUNG ELECTRO-MECHANICS CO., LTD., Suwon-si (KR)

(72) Inventors: Jeong Suong Yang, Suwon-si (KR); Byung Chul Jang, Suwon-si (KR); Jung Deok Park, Suwon-si (KR); Hyeg Soon An, Suwon-si (KR); Su Beom Park, Suwon-si (KR); Jae Seok Yi, Suwon-si (KR); Jung Hyun Lee, Suwon-si (KR)

(73) Assignee: SAMSUNG ELECTRO-MECHANICS CO., LTD., Suwon-si (KR)

(21) Appl. No.: 18/217,780

(22) Filed: Jul. 3, 2023

(30) Foreign Application Priority Data
Nov. 30, 2022 (KR) 10-2022-0164766
Dec. 30, 2022 (KR) 10-2022-0190965

(51) Int. Cl. H01M 4/90; C25B 1/04; C25B 11/073; H01M 4/86; H01M 8/0656; H01M 12/06

(52) U.S. Cl. CPC H01M 4/9025; C25B 1/04; C25B 11/073; H01M 4/8605; H01M 8/0656; H01M 12/06

(57) ABSTRACT

A solid oxide cell includes a fuel electrode, an air electrode, and an electrolyte disposed between the fuel electrode and the air electrode. The fuel electrode may include a porous metal body having pores and a barrier portion disposed in the pores of the porous metal body, and the barrier portion has a shape of at least one of a sheet shape and a flake shape.

### CROSS-REFERENCE TO RELATED APPLICATIONS

This application claims benefit of priority to Korean Patent Application No. 10-2022-0190965 filed on Dec. 30, 2022 and Korean Patent Application No. 10-2022-0164766 filed on Nov. 30, 2022 in the Korean Intellectual Property Office, the disclosures of which are incorporated herein by reference in their entirety.

### TECHNICAL FIELD

The present disclosure relates to a solid oxide cell.

A solid oxide fuel cell (SOFC) and a solid oxide electrolysis cell (SOEC) include a cell composed of an air electrode, a fuel electrode, and a solid electrolyte having oxygen ion conductivity, and in this case, the cell may be referred to as a solid oxide cell. The solid oxide cell produces electrical energy through an electrochemical reaction or electrolyzes water through the reverse reaction of a solid oxide fuel cell to produce hydrogen. Solid oxide cells have low overvoltage based on the low activation polarization, and low irreversible loss, and thus have high efficiency, compared to other types of fuel cells or water electrolysis cells, such as phosphoric acid fuel cells (PAFC), alkali fuel cells (AFC), polymer electrolyte fuel cells (PEMFC), direct methanol fuel cells (DMFC), or the like. In addition, it may be used as carbon or hydrocarbon-based fuel as well as hydrogen, so there is a wide range of fuel choices. Since the reaction rate at the electrode is high, it has the advantage of not requiring expensive precious metals as an electrode catalyst.

Characteristics of the solid oxide cell may be deteriorated when driven in a high-temperature environment. One of the causes of such deterioration is that the reaction rate decreases when the fuel electrode having a porous structure is driven for a long time.

### SUMMARY

An aspect of the present disclosure is to implement a solid oxide cell in which degradation problems may be significantly reduced when driven in a high-temperature environment.

According to an aspect of the present disclosure, a novel structure of a solid oxide cell is provided through an example, and the solid oxide cell includes a fuel electrode including a porous metal body having pores, and a barrier portion disposed in the pores of the porous metal body, where the barrier portion has a shape of at least one of a sheet shape and a flake shape, an air electrode, and an electrolyte disposed between the fuel electrode and the air electrode.

The barrier portion may include a conductor including carbon.

The conductor may include graphene.

The fuel electrode may include a plurality of barrier portions.

At least one of the plurality of barrier portions may not contact other barrier portions.

At least one of the plurality of barrier portions may be spaced apart from a surface of the pores in the porous metal body.

At least one of the plurality of barrier portions may be in contact with a surface of the pores in the porous metal body.

A portion of the plurality of barrier portions may be sheet-shaped, and at least a portion of the remaining barrier portions may be flake-shaped.

At least a portion of the plurality of barrier portions may be in a form of a bent sheet.

The fuel electrode may further include an ion conductor.

The ion conductor may include a ceramic porous body disposed in the pores of the porous metal body.

The porous metal body may contain Ni.

The Barrier Portion May Include a Protective Film Disposed on a Surface of the Barrier Portion.

The protective film may include at least one of B and Al.

According to an aspect of the present disclosure, a solid oxide cell includes a fuel electrode including a porous metal body having pores, and a barrier portion disposed in the pores of the porous metal body, where the barrier portion includes a protective film disposed on a surface of the barrier portion, an air electrode, and an electrolyte disposed between the fuel electrode and the air electrode.

The barrier portion may include a conductor including carbon.

The conductor may include graphene.

The barrier portion may be spaced apart from a surface of the pores in the porous metal body.

The fuel electrode may further include an ion conductor.

The ion conductor may include a ceramic porous body disposed in the pores of the porous metal body.

The protective film may include at least one of B and Al.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is an exploded perspective view schematically illustrating a solid oxide cell according to an embodiment;

FIGS. 2 and 3 are cross-sectional views of a region of a solid oxide cell;

FIG. 4 is an enlarged view of one region of a fuel electrode;

FIGS. 5A and 5B each illustrates the shape of a barrier portion included in a fuel electrode;

FIG. 6 illustrates the form in which metal particles constituting a fuel electrode are sintered;

FIG. 7 illustrates an example of raw material powder for obtaining a fuel electrode;

FIG. 8 illustrates a shape of a barrier portion included in a fuel electrode in a solid oxide cell according to a modified embodiment; and

FIG. 9 is an enlarged view of one region of the fuel electrode in the solid oxide cell according to the modified embodiment.

### DETAILED DESCRIPTION

Hereinafter, embodiments will be described with reference to detailed embodiments and accompanying drawings. However, the embodiments of the present disclosure may be modified in many different forms, and the scope of the present disclosure is not limited to the embodiments described below. In addition, the embodiments of the present disclosure are provided to more completely describe the present disclosure to those skilled in the art. Therefore, the shape and size of elements in the drawings may be exaggerated for clearer explanation, and elements indicated by the same reference numerals in the drawings are the same elements.

To clearly describe the present disclosure in the drawings, parts irrelevant to the description are omitted, and to clearly express the various layers and regions, the thickness is enlarged and illustrated, and elements having the same function within the scope of the same concept are described using the same reference numerals. Furthermore, throughout the specification, when a certain component is said to “include,” it means that it may further include other components without excluding other components unless otherwise stated.

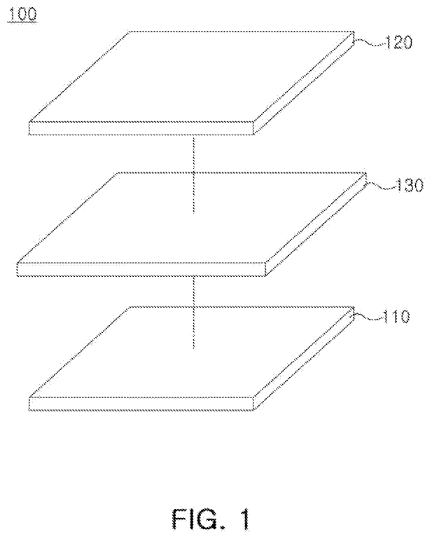

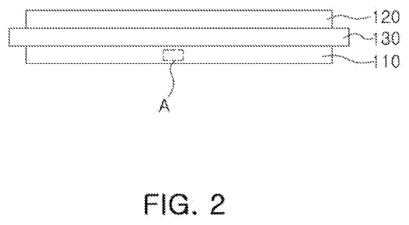

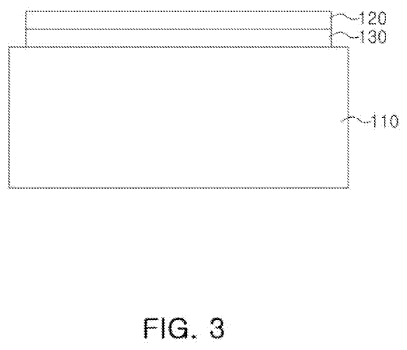

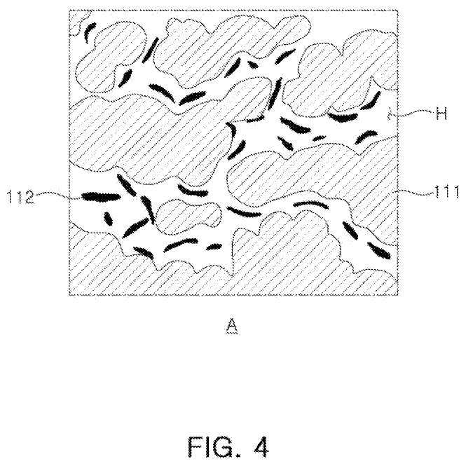

FIG. 1 is an exploded perspective view schematically illustrating a solid oxide cell according to an embodiment. FIGS. 2 and 3 are cross-sectional views of a region of a solid oxide cell. FIG. 4 is an enlarged view of one region of the fuel electrode.

Referring to FIGS. 1 to 4, a solid oxide cell 100 according to an embodiment includes a fuel electrode 110, an air electrode 120, and an electrolyte 130 disposed therebetween as main components. The fuel electrode 110 includes a porous metal body 111 having pores H and a barrier portion 112, and the barrier portion 112 has at least one of a sheet shape and a flake shape. By providing the barrier portion 112 in the fuel electrode 110, metal particles constituting the porous metal body 111 may be prevented from being excessively coarsened, and therefore, a deterioration problem of the solid oxide cell 100 during high-temperature operation may be reduced. Hereinafter, components of the solid oxide cell 100 will be described in detail, and a case in which the solid oxide cell 100 is used as a fuel cell will be mainly described. However, the solid oxide cell 100 may also be used as a water electrolysis cell, and in this case, a reaction opposite to the reaction in the case of a fuel cell will occur in the fuel electrode 110 and the air electrode 120 of the solid oxide cell 100.

In detail, when the solid oxide cell 100 is a fuel cell, for example, in the fuel electrode 110, water generation due to oxidation of hydrogen or an oxidation reaction of carbon compounds may occur, and in the air electrode 120, oxygen ion generation due to decomposition of oxygen may occur. When the solid oxide cell 100 is a water electrolysis cell, the opposite reaction may occur. For example, hydrogen gas may be generated according to a reduction reaction of water in the fuel electrode 110, and oxygen may be generated in the air electrode 120. As another example, when the solid oxide cell 100 is a fuel cell, hydrogen decomposition (hydrogen ion generation) reaction may occur in the fuel electrode 110, and oxygen and hydrogen ions are combined in the air electrode 120 to generate water, and in the case of a water electrolysis cell, decomposition of water (generation of hydrogen and oxygen ions) occurs in the fuel electrode 110, and oxygen may be generated in the air electrode 120. In the electrolyte 130, ions may move to the fuel electrode 110 or the air electrode 120.

On the other hand, the embodiment of FIG. 2 corresponds to the electrolyte 130 supported solid oxide cell 100, and in this case, the width of the electrolyte 130 may be the widest. However, as in the embodiment of FIG. 3, the fuel electrode 110 support type may be implemented, and in this case, the fuel electrode 110 may be the thickest.

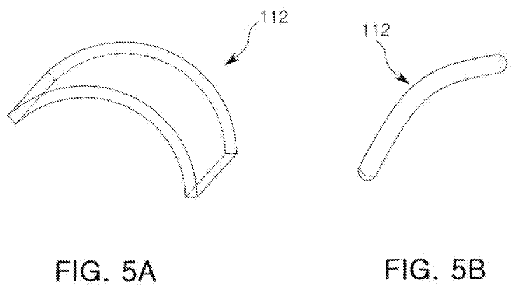

Referring to FIG. 4, the fuel electrode 110 includes a porous metal body 111, and pores H are formed in the porous metal body 111. In addition, in the fuel electrode 110, the barrier portion 112 is disposed in the pores H of the porous metal body 111, and as illustrated in FIGS. 5A and 5B, the barrier portion 112 has a shape of at least one of a sheet shape (see FIG. 5A) and a flake shape (see FIG. 5B). The porous metal body 111 may function as a conductor in the fuel electrode 110 and may also serve as a catalyst for reactions in the fuel electrode 110. The porous metal body 111 may include Ni, and may be obtained, for example, by sintering Ni-containing particles in a reducing atmosphere. In this case, the Ni-containing particles may be Ni oxide particles. In the process of sintering the metal particles, the porous metal body 111 may be obtained, and to this end, a pore former may be added to the mixture before sintering.

The barrier portion 112 may prevent metal particles constituting the porous metal body 111 from becoming excessively large during operation of the fuel electrode 110. For example, when the solid oxide cell 100 is driven, the size of the porous metal body 111 of the fuel electrode 110 may increase due to material movement (e.g., Ni) on the surface of the porous metal body 111. In this case, as the distance between the reaction areas of the fuel material is shortened, the reaction rate may be reduced. The barrier portion 112 may be present in the pores H of the porous metal body 111 to reduce the possibility of such coarsening, and thus, the deterioration of the solid oxide cell 100 may be reduced. A material constituting the barrier portion 112 may be selected in consideration of the material transfer blocking function and electrical conductivity, and in the present embodiment, a conductor of a carbon material is used. As a more detailed example, the conductor may include graphene, and since graphene has relatively high electrical conductivity while effectively blocking the coarsening of metal particles even at a thin thickness, graphene may contribute to improvement of characteristics of the fuel electrode 110 employing the graphene.

The air electrode 120 may include an electrically conductive material, such as, for example, an electrically conductive perovskite material such as lanthanum strontium manganite (LSM). Other conducting perovskites, for example, a metal, such as lanthanum strontium cobalt (LSC), lanthanum strontium cobalt manganese (LSCM), lanthanum strontium cobalt ferrite (LSCF), lanthanum strontium ferrite (LSF), La_{0.85}Sr_{0.15}Cr_{0.9}Ni_{0.1}O₃ (LSCN), or Pt may also be used. In some embodiments, the air electrode 120 may include a mixture of an electrically conductive material and an ionically conductive ceramic material. For example, the air electrode 120 may include about 10% to about 90% by weight of an electrically conductive material (e.g., LSM, etc.) and about 10% to about 90% by weight of an ion conductive material. In this case, the ionically conductive material may further include zirconia-based (e.g., YSZ) and/or ceria-based materials.

The electrolyte 130 is disposed between the fuel electrode 110 and the air electrode 120. As an example of a material constituting the electrolyte 130, the electrolyte 130 may include stabilized zirconia. In detail, the electrolyte 130 may include scandia stabilized zirconia (sSZ), yttria stabilized zirconia (YSZ), scandia ceria stabilized zirconia (SCSZ), scandia ceria yttria stabilized zirconia (SCYSZ), scandia ceria ytterbia stabilized zirconia (SCYbSZ), etc.

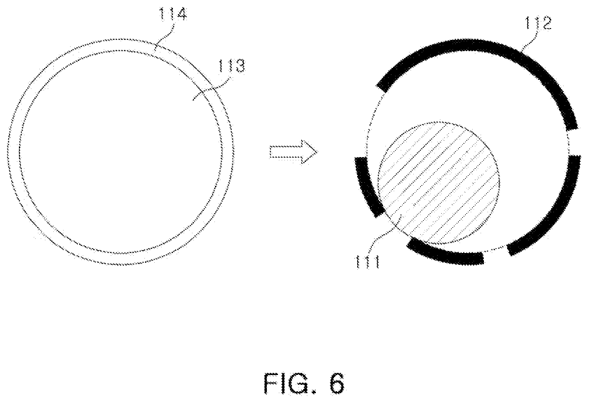

In describing the configuration of the fuel electrode 110 in more detail, a process of forming the porous metal body 111 and the barrier portion 112 will be described with reference to FIG. 6. FIG. 6 illustrates that metal particles constituting the fuel electrode are sintered. First, the raw material powder 113 on which the coating layer 114 is formed is prepared (left side of FIG. 6). The raw material powder 113 includes a metal component constituting the porous metal body 111, for example, Ni, and may include Ni oxide as described above. The coating layer 114 is a region in which the barrier portion 112 is formed after sintering, and a material including graphene or the like may be formed on the surface of the raw material powder 113 before sintering. In this case, as a process of forming the coating layer 114, an appropriate deposition process known in the art may be used, such as thermal or chemical vapor deposition. After sintering, the raw material powder 113 constitutes the porous metal body 111, and the sintering process may be performed in a reducing atmosphere. For example, in a sintering process in a reducing atmosphere, the raw material powder 113 containing Ni oxide may be changed into the porous metal body 111, which is a sintered body of Ni particles. In this process, the size of the raw material powder 113 may be reduced by contraction, and the barrier portion 112 may be fragmented and separated into a plurality of pieces. For example, as illustrated, the fuel electrode 110 may include a plurality of barrier portions 112. In this case as well, unlike the porous metal body 111, the barrier portion 112 may maintain the overall shape of the coating layer 114, as illustrated in the drawings.

As such, when the coating layer 114 remains as the barrier portion 112 after sintering, coarsening of the porous metal body 111 that may occur during driving of the solid oxide cell 100 may be prevented. FIGS. 5A and 5B each illustrates an example of the barrier portion 112 present in the pores H of the porous metal body 111 in the fuel electrode 110. As described above, the fragmented barrier portion 112 may have a sheet shape, in more detail, a bent sheet shape as illustrated in FIG. 5A, and may also have a flake shape as illustrated in FIG. 5B. For example, some of the plurality of barrier portions 112 may have a sheet shape, and at least some of the others may have a flake shape.

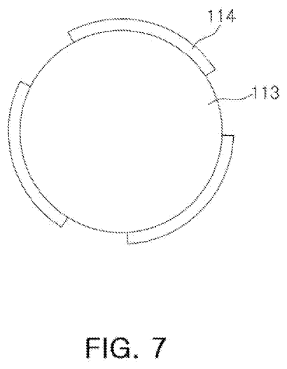

On the other hand, although FIG. 6 illustrates the form in which the entire surface of the raw material powder 113 is covered by the coating layer 114, as illustrated in FIG. 7, the raw material powder 113 having the coating layer 114 formed on only a portion of the surface may also be used. If the coating layer 114 is not fragmented after sintering in the raw material powder 113 of FIG. 6, the catalytic function of the porous metal body 111 may deteriorate. As illustrated in FIG. 7, by using the raw material powder 113 with an exposed portion of the surface, a decrease in reactivity due to a decrease in the catalytic function of the porous metal body 111 may be prevented.

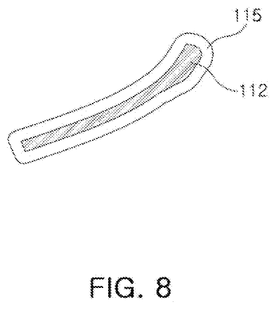

As another modified example, as illustrated in FIG. 8, the barrier portion 112 may further include a protective film 115 formed on the surface thereof. The protective film 115 may function as protecting the barrier portion 112, preventing oxidation, and the like, and may include, for example, at least one of B and Al. In this case, the protective film 115 may be formed of a metal of B or Al or an oxide of B or Al.

The presence of the barrier portion 112 and the protective film 115, and the shape of the barrier portion may be determined by electron microscopy, and/or energy dispersive spectroscopy. Other methods and/or tools appreciated by one of ordinary skill in the art, even if not described in the present disclosure, may also be used.

Referring to FIG. 4 again, a more detailed arrangement method of the barrier portion 112 will be described. In the case of forming the barrier portion 112 using the coating layer 114 as described above, various types of barrier portions 112 may be obtained according to the shape of the coating layer 114, sintering conditions, or the like. First of all, at least one of the plurality of barrier portions 112 may not contact another barrier portion 112. In this case, other parts of the plurality of barrier portions 112 may be in contact with other barrier portions 112. In addition, at least one of the plurality of barrier portions 112 may be spaced apart from the surface forming the pores H in the porous metal body 111. However, at least one of the plurality of barrier portions 112 may be in contact with the surface forming the pores H in the porous metal body 111.

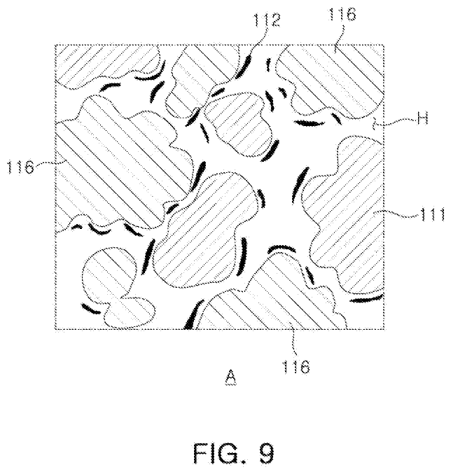

In the above-described embodiment, the structure in which the fuel electrode 110 includes the porous metal body 111 and the barrier portion 112 is illustrated, but as in the embodiment of FIG. 9, the fuel electrode 110 may further include an ion conductor 116. In this case, the ion conductor 116 may be a ceramic porous body structure disposed in the pores H of the porous metal body 111. In the case of the ceramic constituting the ion conductor 116, for example, gadolinia doped ceria (GDC), Samaria doped ceria (SDC), ytterbia doped ceria (YDC), scandia stabilized zirconia (sSZ), ytterbia ceria scandia stabilized zirconia (YbCSSZ), etc. may be included.

As set forth above, in the case of the solid oxide cell according to an embodiment, degradation in characteristics may be significantly reduced even when driven in a high temperature environment. Therefore, performance may be improved when the solid oxide cell is used as a fuel cell or water electrolysis cell.

While example embodiments have been illustrated and described above, it will be apparent to those skilled in the art that modifications and variations could be made without departing from the scope of the present disclosure as defined by the appended claims.

What is claimed is:

1. A solid oxide cell comprising:
a fuel electrode including:
a porous metal body having pores, and
a barrier portion disposed in the pores of the porous metal body, wherein the barrier portion has a shape of at least one of a sheet shape and a flake shape;
an air electrode; and
an electrolyte disposed between the fuel electrode and the air electrode.

2. The solid oxide cell of claim 1, wherein the barrier portion includes a conductor including carbon.

3. The solid oxide cell of claim 2, wherein the conductor includes graphene.

4. The solid oxide cell of claim 1, wherein the fuel electrode includes a plurality of barrier portions.

5. The solid oxide cell of claim 4, wherein at least one of the plurality of barrier portions does not contact other barrier portions.

6. The solid oxide cell of claim 4, wherein at least one of the plurality of barrier portions is spaced apart from a surface of the pores in the porous metal body.

7. The solid oxide cell of claim 4, wherein at least one of the plurality of barrier portions is in contact with a surface of the pores in the porous metal body.

8. The solid oxide cell of claim 4, wherein a portion of the plurality of barrier portions is sheet-shaped, and at least a portion of remaining barrier portions is flake-shaped.

9. The solid oxide cell of claim 4, wherein at least a portion of the plurality of barrier portions is in a form of a bent sheet.

10. The solid oxide cell of claim 1, wherein the fuel electrode further includes an ion conductor.

11. The solid oxide cell of claim 10, wherein the ion conductor includes a ceramic porous body disposed in the pores of the porous metal body.

12. The solid oxide cell of claim 1, wherein the porous metal body contains Ni.

13. The solid oxide cell of claim 1, wherein the barrier portion includes a protective film disposed on a surface of the barrier portion.

14. The solid oxide cell of claim 13, wherein the protective film includes at least one of B and Al.

15. A solid oxide cell comprising:
a fuel electrode including:
a porous metal body having pores, and
a barrier portion disposed in the pores of the porous metal body, wherein the barrier portion includes a protective film disposed on a surface of the barrier portion;
an air electrode; and
an electrolyte disposed between the fuel electrode and the air electrode.

16. The solid oxide cell of claim 15, wherein the barrier portion includes a conductor including carbon.

17. The solid oxide cell of claim 16, wherein the conductor includes graphene.

18. The solid oxide cell of claim 15, wherein the barrier portion is spaced apart from a surface of the pores in the porous metal body.

19. The solid oxide cell of claim 15, wherein the fuel electrode further includes an ion conductor.

20. The solid oxide cell of claim 19, wherein the ion conductor includes a ceramic porous body disposed in the pores of the porous metal body.

21. The solid oxide cell of claim 15, wherein the protective film includes at least one of B and Al.
